(19) United States
(12) Patent Application Publication
(10) Pub. No.: US 2002/0109362 A1
(43) Pub. Date: Aug. 15, 2002

(54) Apparatus and method for assembling and packaging sandwiches

(76) Inventor: Leta M. Long, Modesto, CA (US)

Correspondence Address: ROBERT S. SMITH, LAW OFFICES OF ROBERT S. SMITH, 1131-O TOLLAND TURNPIKE, SUITE 306, MANCHESTER, CT, 06040, US

(21) Appl. No.: 09/782,655

(22) Filed: Feb. 13, 2001

(51) Int. Cl. A47J 43/28

(52) U.S. Cl. 294/1.1; 294/7

(57) ABSTRACT

Apparatus for assembling and packaging a sandwich which includes a planar base for use with associated slices of bread. The planar base is generally rectangular and has a width that is greater than the width of the associated slice of bread and a height that is greater than the height of the associated slice of bread, a first upstanding lip extending along a first side of the planar base. The first upstanding lip has a height that is greater than the height of an associated sandwich that is assembled on the planar base; and a second upstanding lip extending along a second side of the planar base. The second upstanding lip is disposed on a side of the generally planar base that is adjacent to the first side. The second upstanding lip has a height that is greater than the height of an associated sandwich that is assembled on the planar base. In some forms of the invention at least one of the upstanding lips has rounded corners. The apparatus may have a first upstanding lip that has a shape that is generally rectangular. The second upstanding lip may have an extremity most remote from the first upstanding lip that tapers to an intersection with the planar base.

### BACKGROUND OF THE INVENTION

The invention relates to food and meal preparation and particularly to apparatus and methods for assembling sandwiches. Hundreds of millions of sandwiches are assembled every day. Almost all are made in an unstructured, uncontrolled manner. Typically, after assembly of the sandwich on a counter, it is picked up by hand and placed in a plastic bag or baggy or wrapped in paper or a plastic film. Commercial establishments have employed some devices for holding sandwiches, however, such apparatus and method has been cumbersome and impractical for home and small business applications.

The major problem with the prior art methods of assembling a sandwich is the handling time involved in making a sandwich. In addition, conventional sandwich making is a messy job and some ingredients of the sandwich tend to spill out of the final sandwich. Attempts to manually compact the sandwich to restrain such ingredients compromises the appearance of the sandwich making the sandwich appear unappetizing. In some cases, manually compacting the sandwich may damage the bread and the various ingredients of the sandwich. As in the preparation of all foodstuffs, sanitary procedures are of paramount importance.

### SUMMARY OF THE INVENTION

It is an object of the present invention to provide a more convenient means for a homemaker or even children to make sandwiches.

Another object invention is to provide apparatus which will make it easier for the person assembling the sandwich to place the complete sandwich into a plastic bag or baggy.

An additional object invention is to provide a method and apparatus that will reduce spillage of the ingredients of the sandwich during the assembly of the sandwich and packaging of the sandwich.

Still another object invention is to provide a method and apparatus that will avoid contact of the sandwich and the outside of the plastic bag or baggy into which the sandwich is deposited so that the plastic bag or baggy will have an external surface that is clean.

Yet another object of the invention is to provide a method and apparatus that will minimize hand contact with the sandwich and thus be more sanitary and avoid finger impressions in the sandwich.

It is now been found that these other objects of the invention may be attained in apparatus for assembling and packaging a sandwich that includes a planar base for use with associated slices of bread, the planar base being generally rectangular and having a width that is greater than the width of the associated slice of bread and a height that is greater than the height of the associated slice of bread, a first upstanding lip extending along a first side of the planar base, the first upstanding lip having a height that is greater than the height of an associated sandwich that is assembled on the planar base; and a second upstanding lip extending along a second side of the planar base, the second upstanding lip being disposed on a side of the generally planar base that is adjacent to the first side, the second upstanding lip having a height that is greater than the height of an associated sandwich that is assembled on the planar base.

In some forms of the invention at least one of the upstanding lips has rounded corners. Some embodiments may have a first upstanding lip that has a shape that is generally rectangular and a second upstanding lip that has an extremity most remote from the first upstanding lip that tapers to an intersection with the planar base.

### BRIEF DESCRIPTION OF THE DRAWING

The invention will be better understood by reference the accompanying drawing in which:

FIG. 1 is a perspective view of a preferred embodiment of the apparatus in accordance with the present invention.

FIG. 2 is a perspective view of the embodiment illustrated in FIG. 1 with an assembled sandwich disposed thereon.

FIG. 3 it is a partially schematic perspective view of the sandwich and apparatus of FIG. 2 being inserted into a plastic bag.

FIG. 4 is a partially schematic perspective view of the sandwich and apparatus of FIG. 2 fully inserted into a plastic bag.

FIG. 5 is a partially schematic perspective view of the withdrawal of the apparatus from the plastic bag with the sandwich left within the plastic bag.

FIG. 6 is a partially schematic perspective view of the sandwich disposed within a plastic bag after the bag has been sealed.

### DESCRIPTION OF THE PREFERRED EMBODIMENT

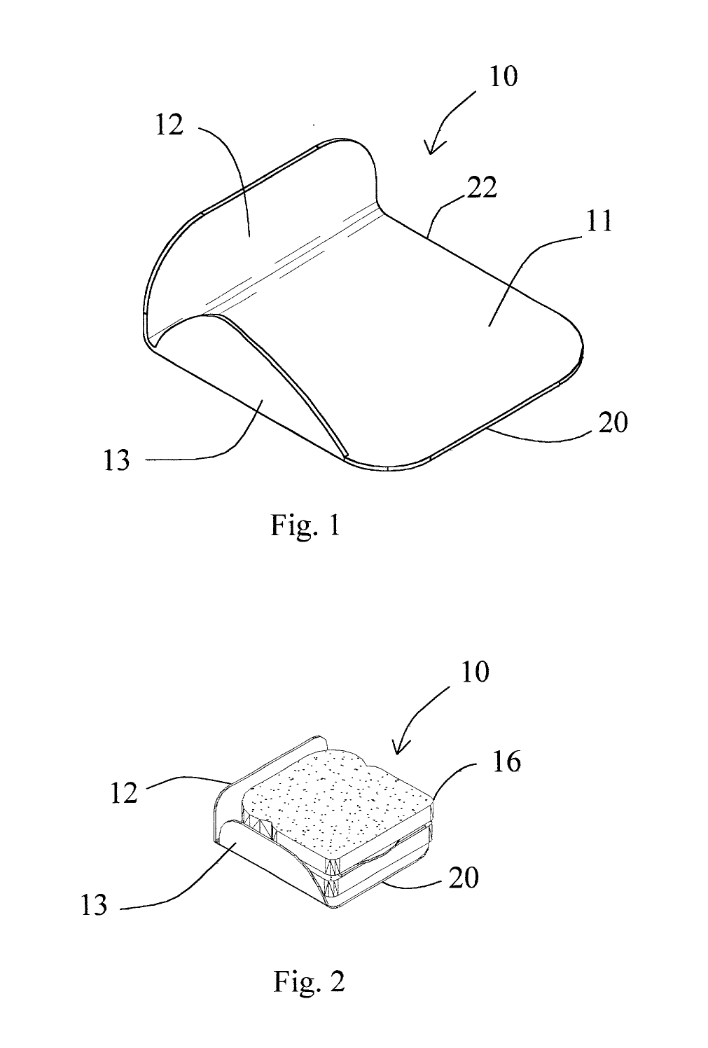

Referring now to FIG. 1 there is shown the so-called sandwich helper apparatus 10 in accordance with a preferred form of the invention. The sandwich helper apparatus 10 is preferably manufactured from a one-piece vacuum or heat formed plastic material having a thickness of approximately ⅛ of an inch. The sandwich helper apparatus 10 in the preferred embodiment has a generally planar or flat base 11. The base 11 is approximately four inches wide by approximately 4.25 inches long. The dimensions of the preferred embodiment are for a typical sandwich bread. Other dimensions may be utilized when the apparatus 10 is used with breads of other sizes. Flanges are disposed along two adjacent sides which will be referred to herein as a back 12 and an adjacent side 13. The back 12 has a height of approximately 1.5 inch and extends substantially along the entire back 12. The back 12, as are all other parts of the sandwich helper 10, manufactured so that all edges and surfaces are rounded and smooth and free of any sharp corners or edges.

The dimensions of the structure will vary with the specific bread that is being used, although, is generally preferred that the sandwich helper apparatus 10 has overall dimensions are slightly wider, longer and higher than in the sandwich that is prepared with the aid of the sandwich helper apparatus 10. This dimensional relationship promotes proper control and structure in the assembly of the sandwich as well as enabling easy insertion of the apparatus 10 and the assembled sandwich into a plastic bag. Although the present invention has particular application to insertion of an assembled sandwich into a plastic bag, those skilled in the art will recognize that the user may completely assembly the sandwich, place the combination of the helper apparatus 10 and the assembled sandwich on a sheet of wax paper or aluminum foil, and slide the sandwich off of the sandwich helper 10 prior to final wrappings of the sandwich.

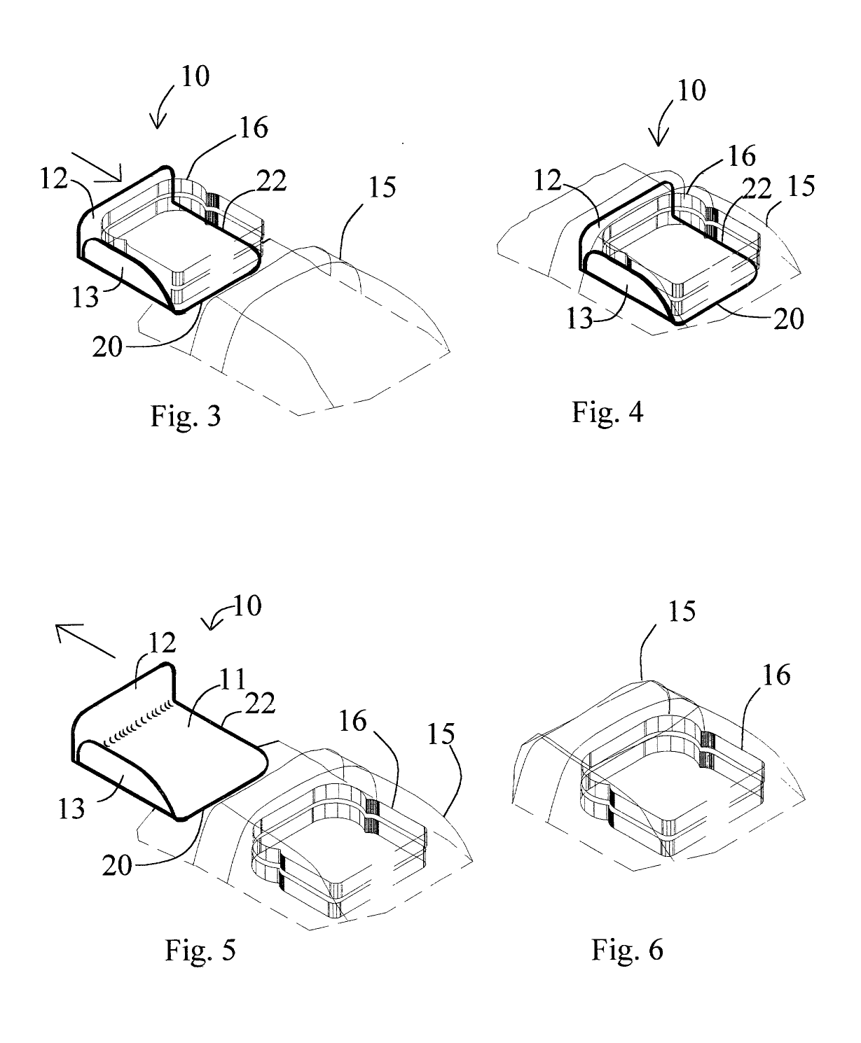

The sandwich helper apparatus 10 is normally placed on a work surface (not shown) and a sandwich is assembled in the normal manner. More particularly, the sandwich is assembled with the top of each slice of bread disposed in abutting relationship to the back 12 and an adjacent side of each slice of bread disposed in abutting relationship to the adjacent side 13 of the sandwich helper apparatus 10. For convenience of description the other two sides of the sandwich helper apparatus 10 will be referred to as having a side that is opposite to the back 12 that is referred to herein as the front 20 and a side 22 that is opposite the adjacent side 13. In the preferred embodiment of the sandwich helper apparatus the front 20 and the side 22 have no uptstanding planar member. As best shown in FIG. 3 the sandwich helper apparatus 10 has a sandwich 16 disposed thereon. Preferably the front 20 is inserted into the bag 15 first. After the sandswich helper apparatus 10 has assisted the user in placing a sandwich and sandwich helper apparatus 10 within a plastic bag 15 the sandwich helper apparatus 10 is withdrawn as best seen in FIG. 5. Thereafter the bag 15 is sealed in a conventional manner.

The sandwich helper apparatus 10 in accordance with present invention permits fast assembly of sandwiches having more uniform quality standards and which minimizes manual handling of the sandwich. Particularly if the sandwich is moist or the bread is very fresh or very soft manual handling may result in finger impressions in the bread that compromise the appearance of the final sandwich assembly. The helper 10 in accordance with present invention minimizes direct manual handling and thus minimizes such finger impressions.

The invention has been described in terms of an embodiment in which the side 13 is disposed on a side that might best be categorized as being to the left of the back 12. It will be understood by those skilled in the art that alternatively the structure may have a 13 that may be disposed to the right of the back 12. This other form of the invention may be of greatest interest to users who are left-handed and may find such an embodiment to be more convenient.

Although a specific embodiment of the invention has been illustrated and described herein, it will be appreciated by those of ordinary skill in the art that any arrangement that is calculated to achieve the same purpose may be substituted for the specific embodiment shown. This application is intended to cover any adaptation or variations of the present invention. Therefore, it is manifestly intended that this invention be limited only by the claims and the equivalents thereof.

I claim:

1. Apparatus for assembling and packaging a sandwich which comprises:
a planar base for use with associated slices of bread, the planar base is generally rectangular and having a width that is greater than the width of the associated slice of bread and a height that is greater than the height of the associated slice of bread,
a first upstanding lip extending along a first side of said planar base, said first upstanding lip having a height that is greater than the height of an associated sandwich that is assembled on said planar base; and
a second upstanding lip extending along a second side of said planar base, said second upstanding lip being disposed on a side of said generally planar base that is adjacent to said first side, said second upstanding lip having a height that is greater than the height of an associated sandwich that is assembled on said planar base.

2. The apparatus in accordance with claim 1 wherein at least one of said upstanding lips has rounded corners.

3. The apparatus in accordance with claim 2 wherein said first upstanding lip has a shape that is generally rectangular.

4. The apparatus in accordance with claim 3 wherein said second upstanding lip has an extremity most remote from said first upstanding lip that tapers to an intersection with said planar base.

5. The apparatus in accordance with claim 4 wherein said second upstanding leg is on the right side.

6. 5. The apparatus in accordance with claim 4 wherein said second upstanding leg is on the left side.
